(19) United States
(12) Patent Application Publication
(10) Pub. No.: US 2026/0169027 A1
(43) Pub. Date: Jun. 18, 2026

(54) METHOD AND APPARATUS FOR MEASURING DIFFUSED CHARGES

(71) Applicants: Samsung Electronics Co., Ltd., Suwon-si (KR); KOREA ADVANCED INSTITUTE OF SCIENCE AND TECHNOLOGY, Daejeon (KR)

(72) Inventors: Seokhoon CHOI, Suwon-si (KR); Jeongyoung PARK, Daejeon (KR); Sungmin YOON, Daejeon (KR); Sunho KIM, Suwon-si (KR); Seungyeul YANG, Suwon-si (KR); Minhyun LEE, Suwon-si (KR); Seonghun JANG, Suwon-si (KR)

(73) Assignees: Samsung Electronics Co., Ltd., Suwon-si (KR); KOREA ADVANCED INSTITUTE OF SCIENCE AND TECHNOLOGY, Daejeon (KR)

(21) Appl. No.: 19/407,840

(22) Filed: Dec. 3, 2025

(30) Foreign Application Priority Data
Dec. 16, 2024 (KR) 10-2024-0187471

(51) Int. Cl. G01Q 60/38

(52) U.S. Cl. CPC G01Q 60/38

(57) ABSTRACT

A method and apparatus for measuring diffused charges are provided. The method includes trapping charges in a first region of a sample, inspecting a first region of the sample and a second region of the sample, the second region being adjacent to the first region, by using an atomic force microscope, and obtaining information about the charges diffused in the second region by using a result of the inspecting.

### CROSS-REFERENCE TO RELATED APPLICATION

This application is based on and claims priority under 35 U.S.C. § 119 to Korean Patent Application No. 10-2024-0187471, filed on Dec. 16, 2024, in the Korean Intellectual Property Office, the disclosure of which is incorporated by reference herein in its entirety.

### BACKGROUND

Some example embodiments relate, in general, to a method and/or apparatus for measuring diffused charges, and more particularly, to a method and/or apparatus for measuring diffused charges by using an atomic force microscope.

When conducting a semiconductor process, it is necessary or desirable to monitor the structure of a device formed at each process to confirm that the structure satisfies a desired goal. For example, techniques such as threshold voltage measurement and capacitance-voltage (C-V) measurement may be used to measure the amount of trapped charges (holes and/or electrons) by applying voltage to a memory device including a charge trap layer (CTL).

In order to measure a threshold voltage, a device that includes a gate electrode, a source electrode, and a drain electrode in addition to the charge trap layer is to be manufactured, and thus the manufacture of the device for measurement may take a lot of time.

In the C-V measurement method, the capacitance of the entire device including the charge trap layer is measured. Thus, the capacitance existing in other layers other than the charge trap layer to be evaluated may also be measured, which may reduce the accuracy of the measurement.

### SUMMARY

Some example embodiments include a method and/or an apparatus for measuring diffused charges in a charge trap layer.

Additional aspects will be set forth in part in the description which follows and, in part, will be apparent from the description, or may be learned by practice of the presented embodiments of the disclosure.

According to some example embodiments, a method includes trapping charges in a first region of a sample, inspecting a first region of the sample and a second region of the sample, the second region adjacent to the first region, the inspecting by using an atomic force microscope, and obtaining information about the charges diffused in the second region by using a result of the inspecting. The sample includes a first conductive layer, a semiconductor layer on the conductive layer, a charge tunneling layer disposed on the semiconductor layer, a charge trap layer on the charge tunneling layer, a charge blocking layer on the charge trap layer, and a second conductive layer on the charge blocking layer. The second conductive layer is disposed in the first region but not in the second region.

The method may further include heating the sample after trapping the charges.

The trapping of the charges may include trapping electrons in a region included in the first region of the charge trap layer by applying a positive voltage to the second conductive layer.

The trapping of the charges may include trapping holes in a region included in the first region of the charge trap layer by applying a negative voltage to the second conductive layer.

The trapping of the charges may include applying voltage to the sample through a tip of the atomic force microscope.

The inspecting may be performed while the first conductive layer and the second conductive layer are grounded.

The inspecting may be performed while the atomic force microscope is in a non-contact mode.

The non-contact mode may include a Kelvin probe force microscope (KPFM) mode.

The obtaining of the information about diffused charges may include obtaining surface potential profiles of the first region and the second region, normalizing the surface potential profile of the second region based on the surface potential profile of the first region, and obtaining a diffusion coefficient of the charge trap layer from the normalized surface potential profile.

The normalized surface potential profile may be based on a difference between an average value of the surface potential profiles of the first region and the surface potential profile of the second region.

The diffusion coefficient of the charge trap layer may be based on a standard deviation of the normalized surface potential profile.

The charge tunneling layer and the charge blocking layer may include a same material as each other.

At least one of the charge tunneling layer and the charge blocking layer may include silicon oxide.

A thickness of the charge blocking layer may be greater than a thickness of the charge tunneling layer.

The charge trap layer may include silicon nitride.

The first conductive layer may include a printed circuit board (PCB) substrate.

Alternatively or additionally according to some example embodiments, an atomic force microscope includes a tip configured to provide a voltage to a first region of a sample to trap charges in the sample, a cantilever on which the tip is mounted, a controller configured to apply a direct-current (DC) voltage and an alternating-current (AC) voltage to the cantilever while the tip scans a first region of the sample and a second region of the sample, the second region adjacent to the first region, and a processor configured to obtain surface potential profiles of the first region and the second region of the sample through a DC voltage corresponding to a potential of the sample. The sample includes a first conductive layer, a semiconductor layer disposed on the conductive layer, a charge tunneling layer on the semiconductor layer, a charge trap layer on the charge tunneling layer, a charge blocking layer on the charge trap layer, and a second conductive layer on the charge blocking layer. The second conductive layer is in the first region but not in the second region.

The processor may be further configured to normalize a surface potential profile of the second region based on a surface potential profile of the first region, and obtain information about the diffused charges by obtaining a diffusion coefficient of the charge trap layer from the normalized surface potential profile.

The normalized surface potential profile may be based on a difference between an average value of the surface potential profiles of the first region and the surface potential profile of the second region.

The diffusion coefficient of the charge trap layer may be based on a standard deviation of the normalized surface potential profile.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic diagram illustrating an atomic force microscope according to some example embodiments;

FIG. 2 is a diagram illustrating a memory device including a charge trap layer, according to some example embodiments;

FIG. 3 illustrates a sample schematically illustrating a memory device of FIG. 2, according to some example embodiments;

FIG. 4 is a flowchart illustrating a method of measuring a sample using an atomic force microscope, according to some example embodiments;

FIGS. 5A to 5C are reference diagrams illustrating a method of trapping electrons in a first region of a sample, according to some example embodiments;

FIGS. 6A to 6C are reference diagrams illustrating a method of trapping holes in a first region of a sample, according to some example embodiments;

FIG. 7A is a diagram illustrating a surface potential profile before trapping charges in a sample including a charge trap layer, according to some example embodiments;

FIG. 7B is a diagram illustrating a surface potential profile after heating the sample including the trapped charges, according to some example embodiments;

FIG. 7C is a diagram illustrating a surface potential profile after heating the sample including the trapped charges, according to some example embodiments;

FIG. 8A is a surface potential profile measured after heating a sample including trapped electrons for 10 hours, according to some example embodiments;

FIG. 8B is a surface potential profile measured after heating a sample including trapped electrons for 20 hours, according to some example embodiments;

FIG. 8C is a surface potential profile measured after heating a sample including trapped electrons for 30 hours, according to some example embodiments;

FIG. 8D is a surface potential profile measured after heating a sample including trapped electrons for 40 hours, according to some example embodiments; and

FIG. 8E is a graph showing a square of a standard deviation of a Gaussian-fitted surface potential profile over time, according to some example embodiments.

### DETAILED DESCRIPTION

Reference will now be made in detail to embodiments, examples of which are illustrated in the accompanying diagrams, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Hereinafter, a method and apparatus for obtaining diffused charge information according to various embodiments will be described in detail with reference to the attached drawings. In the following drawings, the same reference numerals refer to the same elements, and the size of each element in the drawings may be exaggerated for clarity and convenience of description.

The singular forms include the plural forms unless the context clearly indicates otherwise. It should be understood that, when a part “comprises” or “includes” an element in the specification, unless otherwise defined, other elements are not excluded from the part and the part may further include other elements.

Additionally, the size or thickness of each element in the drawings may be exaggerated for clarity of description. In addition, when it is described that a given material layer exists on a substrate or another layer, the material layer may exist in direct contact with the substrate or another layer, or there may be a third layer therebetween. In addition, the materials forming each layer in the embodiments below are examples, and other materials may be used.

Also, in the specification, the term “ . . . units” or “ . . . modules” denote units or modules that process at least one function or operation, and may be realized by hardware, software, or a combination of hardware and software.

The particular implementations shown and described herein are illustrative examples of the disclosure and are not intended to otherwise limit the scope of the disclosure in any way. For the sake of brevity, conventional electronics, control systems, software development and other functional aspects of the systems may not be described in detail.

Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device.

The use of the terms “a”, “an” and “the” and similar referents are to be construed to cover both the singular and the plural.

The steps of a method may be performed in any suitable order unless there is an explicit statement that the steps are to be performed in the order described. The use of any and all examples, or exemplary language (e.g., “such as”) provided herein, is intended merely to better illuminate the disclosure and does not pose a limitation on the scope of the disclosure unless otherwise claimed.

Expressions such as “at least one” preceding a list of elements qualify the entire list of elements, not individual elements within the list. For example, expressions such as “at least one of A, B, and C” or “at least one selected from the group consisting of A, B, and C” could be interpreted as A only, B only, C only, or any combination of two or more of A, B, and C, such as ABC, AB, BC, and AC.

When “approximately” or “substantially” is used in connection with a numerical value, the relevant numerical value may be interpreted to include a manufacturing or operating variance (e.g., ±10%) around the stated numerical value. Additionally, when the terms “generally” and “substantially” are used in reference to geometric shapes, it may be intended that no geometric precision is required and that tolerance for shapes is within the scope of the disclosure. Additionally, regardless of whether a value or shape is defined as “approximately” or “substantially,” such values and shapes may be construed to include a manufacturing or operating variance (e.g., ±10%) around the stated value or shape.

The terms “first, second,” etc. may be used to describe various elements, but the elements should not be limited by the terms. The above terms are used solely to distinguish one element from another.

The use of any and all examples, or exemplary language provided herein, is intended merely to better illuminate the disclosure and does not pose a limitation on the scope of the disclosure unless otherwise claimed.

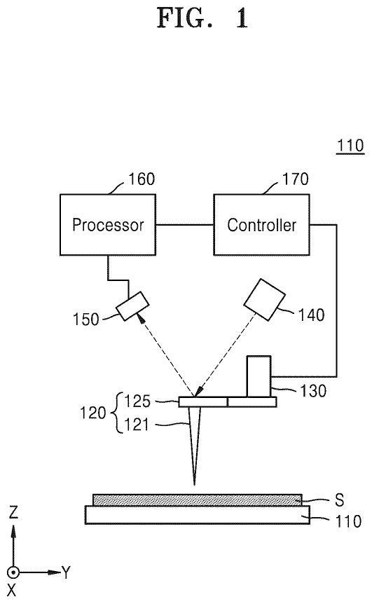

FIG. 1 is a schematic diagram illustrating an atomic force microscope 100 according to embodiments. Measurement using the atomic force microscope 100 according to some example embodiments may include local surface analysis using a probe, which may increase the accuracy of measurement.

Referring to FIG. 1, the atomic force microscope 100 may include a sample support 110, a probe 120, a scanner 130, a light source 140, a light detector 150, a processor 160, and a controller 170.

The atomic force microscope 100 may detect a surface of a sample S with sensitivity at the level of individual atoms that are on a surface of the sample S. The atomic force microscope 100 may inspect the sample S through various interactions between a tip 121 of the probe 120 and the sample S, such as one or more of van der Waals force, electrostatic force, magnetic force, etc. The atomic force microscope 100 may inspect the sample S by horizontally and/or vertically raster-scanning the tip 121 on the surface of the sample S; example embodiments are not limited thereto.

For convenience of illustration, the size of the tip 121 is greatly exaggerated compared to the actual scale, but a Z-direction length of the tip 121 may be in a range of several nm to several hundred nm.

The atomic force microscope 100 may include any one or more of a contact atomic force microscope (AFM), a scanning polarization force microscope (SPFM), a force modulus microscope (FMM), a lateral force microscope (LFM), a scanning capacitance microscope (SCM), a scanning thermal microscope (SThM), a non-contact AFM, a conductive (C) AFM, a dynamic force microscope (DFM), an electrostatic force microscope (EFM), a Kelvin probe force microscope (KPFM), a magnetic force microscope (MFM), a piezoelectric force microscope (PFM), and a dynamic contact AFM.

The atomic force microscope 100 may operate in one or more of a contact mode, a non-contact mode, and a tapping mode. When the atomic force microscope 100 operates in a contact mode, a distance between the tip 121 and the surface of the sample S may be several angstroms. At a distance of about a few angstroms, a repulsive force is dominant between the tip 121 and the surface of the sample S. In a contact mode, a tip 121, which is soft, may be used to prevent or reduce the likelihood of and/or impact from damage to the sample S. Since the change in force applied to the tip 121 is relatively large depending on the change in the distance between the tip 121 and the surface of the sample S in a repulsive territory, the surface of the sample S may be measured.

When the atomic force microscope 100 operates in a non-contact mode, the distance between the tip 121 and the surface of the sample S may be several hundred angstroms or more. At distances of the order of several hundred angstroms, attractive force is dominant between the tip 121 and the surface of the sample S. In non-contact mode, the tip 121, which is hard, may be used to prevent or reduce the likelihood of and/or impact from contact between the tip 121 and the sample S surface by force. In particular, a KPFM mode among non-contact modes may measure a surface potential and/or contact potential difference of various materials by detecting a long-range electrostatic potential with a direct-current voltage.

In a tapping mode, the tip 121 vibrates over the sample S to generate only short, intermittent contact, thereby minimizing or reducing damage to the sample S caused by contact between the tip 121 and the sample S. A tapping mode operation may prevent or reduce damage to the sample S by sensing the sample S by applying a constant vibration to the tip 121.

The sample S to be measured may be arranged on a sample support 110.

The sample support 110 may be or include a vacuum chuck and/or an electrostatic chuck. The sample support 110 may three-dimensionally translate the sample S or rotate the sample S so that the sample S may be scanned by a probe.

Hereinafter, two directions parallel to an upper surface of the sample S (e.g., the opposite surface to a lower surface thereof facing the sample support 110) are defined as an X direction and a Y direction, respectively, and a direction perpendicular to the upper surface of the sample S is defined as the Z direction. The X, Y and Z directions may be substantially perpendicular to each other.

The probe 120 may include a cantilever 125 and the tip 121 connected to an end of the cantilever 125. The cantilever 125 may be or include, for example, a plate-shaped spring that may be easily bent by a minute force of the order of several nano-newtons (N). An end of the tip 121 may be processed to a size of several atoms using nanotechnology. A resolution of the atomic force microscope 100 may depend on the sharpness of the end of the tip 121.

The scanner 130 may scan the sample S by driving the probe 120 in the X and Y directions. During scanning of the sample S, the tip 121 may be deflected by attractive or repulsive forces from features on the surface of the sample S. The deflection of the tip 121 causes bending of the cantilever 125. The bending of the cantilever 125 may be detected by an optical lever consisting of or including the light source 140 and the light detector 150.

The light source 140 may generate a laser beam through oscillation. The laser beam is irradiated onto the end of the cantilever 125, reflected from the end of the cantilever 125, and directed to the light detector 150. The light detector 150 may include photodiodes divided into two segments or four segments, depending on the measurement method. The light detector 150 may amplify and detect small deflections of the cantilever 125 by sensing a laser beam.

The controller 170 may precisely control a Z-direction position of the scanner 130. For example, the controller 170 may control the scanner 130 such that a Z-direction distance between the tip 121 and the surface of the sample S is constant.

As another example, the controller 170 may control the scanner 130 such that a force between the tip 121 and the surface of the sample S is constant.

For example, in a KPFM mode, the controller 170 may apply a first alternating-current (AC) voltage having a vibration frequency Wo to the tip 121 to vibrate the tip 121 near a resonant frequency. When the tip 121 approaches the surface of the sample S, a van der Waals force acts between the sample S and the tip 121, and accordingly, the amplitude of the vibration may change. The controller 170 may adjust a height of the tip 121 so that the tip 121 does not hit the surface of the sample S based on a change in amplitude of the vibration. A laser beam emitted from the light source 140 may be reflected from the end of the cantilever 125 and directed to the light detector 150. Based on the laser beam sensed by the light detector 150, the processor 160 may generate a topographic image of the sample S by storing a Z position of the scanner 130 (or a position of the probe 120) according to the X-direction and Y-direction coordinates thereof on the sample S.

Additionally, the controller 170 may apply a second alternating-current (AC) voltage having a lower frequency than the resonant frequency and a direct-current (DC) voltage of a certain amplitude to the tip 121. When the tip 121 and the surface of the sample S are assumed to be two parallel plates, a bias voltage V(t) applied to the tip 121 may be as shown in Equation 1.

$$V ( t ) = {V}_{DC} - {V}_{sample} + {V}_{AC} sin ( ω t ) \qquad [ Equation 1 ]$$

For example, the bias voltage V(t) may be based on a second alternating-current voltage V_{AC} sin(ωt), which is an alternating-current (AC) component that mechanically resonates the tip 121, a direct-current (DC) voltage V_{DC} applied to the tip 121, and a potential of the sample S, Vₛₐₘₚₗₑ.

The controller 170 has a resonant frequency of O when a DC voltage corresponding to the potential of the sample S is applied, and the processor 160 may obtain a contact potential difference (CPD) and/or a surface potential (SP) of the sample S through the DC voltage corresponding to the potential of the sample S.

When there are many electrons trapped in the sample S and/or if the sample S is a material with a low work function, the surface potential may decrease. Conversely, when there are many holes trapped in the sample S and/or if the sample S is a material with a high work function, the surface potential may increase.

A first AC voltage and a second AC voltage applied to the tip 121 may be applied simultaneously or at least partly simultaneously or separately. A series of processes for obtaining one or more of a surface shape image, surface potential (SP), etc. of the sample S using the atomic force microscope 100 according to some example embodiments may be referred to as inspecting the sample S.

According to some example embodiments, the sample S may be or may include a semiconductor device. For example, the sample S may be or include a device including a charge trap layer during a process of manufacturing a semiconductor device, or a completed memory device. However, the disclosure is not limited thereto. The sample S may be a device schematically representing a charge trap layer included in a memory device.

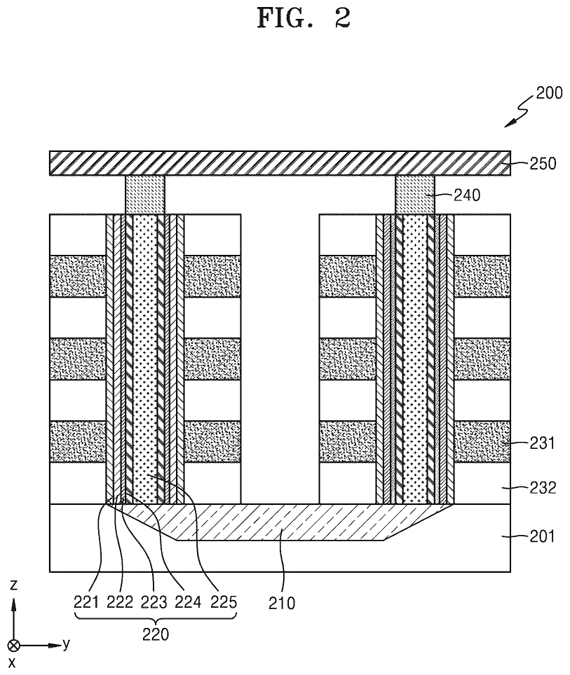

FIG. 2 is a diagram illustrating a memory device including a charge trap layer, according to some example embodiments.

A plurality of cell strings CS may be formed on a substrate 201.

The substrate 201 may include a silicon material doped with a first type impurity. For example, the substrate 201 may include a silicon material doped with a p-type impurity. For example, the substrate 201 may be a p-type well (e.g., a pocket p-well). Hereinafter, it is assumed that the substrate 201 is p-type silicon. However, the substrate 201 is not limited to p-type silicon.

A common source area 210 is provided on the substrate 201. For example, the common source area 210 may have a second type different from that of the substrate 201. For example, the common source area 210 may have an n-type. Hereinafter, the common source area 210 is assumed to be n-type. However, the common source area 210 is not limited to n-type.

A cell string CS includes a channel hole 220 that is cylindrical and a plurality of gate electrodes 231 and a plurality of separation layers 232 surrounding the channel hole 220 in a ring shape. The plurality of gate electrodes 231 and the plurality of separation layers 232 may be alternately stacked in a vertical direction (Z-direction). A thickness of the plurality of gate electrodes may be the same as, or different from, a thickness of the plurality of separation layers; example embodiments are not limited thereto.

The gate electrodes 231 may include a metal material and/or a highly doped silicon material such as a highly doped polysilicon material.

The separation layers 232 may act as a spacer for insulation between the gate electrodes 231. The separation layers 232 may include various insulating materials such as silicon, silicon oxide, and silicon nitride.

The channel hole 220 may be formed to penetrate the gate electrodes 231 and the separation layers 232. Here, the channel hole 220 may extend in a direction perpendicular to a surface of the substrate 201 (e.g., a z-axis direction in FIG. 2). The channel hole 220 may have a circular cross-section; example embodiments are not limited thereto.

The channel hole 220 may include a plurality of layers. A charge blocking layer 221, a charge trap layer 222, a charge tunneling layer 223, a channel layer 224, and a pillar 225 may be sequentially provided on an inner wall of the channel hole 220. Here, when a certain voltage is applied to the gate electrode 231, information may be stored by allowing charges flowing in the channel layer 224 to pass through the charge tunneling layer 223 and be captured in the charge trap layer 222.

Each of the charge blocking layer 221, the charge trap layer 222, and the charge tunneling layer 223 may be arranged to extend in a direction perpendicular to the surface of the substrate 201. Each of the charge blocking layer 221, the charge trap layer 222, and the charge tunneling layer 223 may have a cylindrical shape.

The charge blocking layer 221 may be provided on the inner wall of the channel hole 220 to be in contact with the gate electrode 231 and the separation layer 232. The charge blocking layer 221 may perform a barrier function to block movement of charges between the charge trap layer 222 and the gate electrode 231. A first surface of the charge blocking layer 221 may be in contact with the charge trap layer 222, and a second surface thereof facing the first surface may be in contact with the gate electrode 231. The charge blocking layer 221 may include, for example, silicon oxide or metal oxide, but is not limited thereto.

The charge trap layer 222 may store introduced charges. Charges (e.g., electrons) present in the channel layer 224 may flow into the charge trap layer 222 by a tunneling effect or the like. The charges introduced into the charge trap layer 222 may be fixed to the charge trap layer 222. The charge trap layer 222 may include an amorphous oxide nitride. The charge trap layer 222 is to be described later.

The charge tunneling layer 223 may be a layer in which charge tunneling occurs, and may include, for example, silicon oxide or metal oxide, but is not limited thereto.

The channel layer 224 may include a semiconductor material doped with the first type impurity. The channel layer 224 may include a silicon material doped with a same type as that of the substrate 201, for example, if the substrate 201 includes a p-type doped silicon material, the channel layer 224 may also include a p-type doped silicon material. Alternatively, the channel layer 224 may include a material such as Ge, IGZO, or GaAs. The channel layer 224 may have a cylindrical shape. In some example embodiments, the channel layer 224 may also include impurities of the second type at a much lower dopant concentration than impurities of the first type, example embodiments are not limited thereto.

The pillar 225 may be arranged inside the channel layer 224. The pillar 225 may include, but is not limited to, silicon oxide and/or air.

The channel layer 224 may be in contact with a doping region, e.g., the common source area 210.

A drain 240 may be provided on the channel hole 220. The drain 240 may include a silicon material doped with a second type impurity. For example, the drain 240 may include a silicon material doped with an n-type impurity.

A bit line 250 may be provided on the drain 240. The drain 240 and the bit line 250 may be connected through contact plugs.

The charge trap layer 222 according to some example embodiments may have a high permittivity and a high trap density. A permittivity of the charge trap layer 222 may be about 9 or more, about 12 or more, or about 20 or less. A trap level of the charge trap layer 222 may be about 1.2 eV, about 1.5 eV, about 2 eV, or about 3 eV or less. The trap density of the charge trap layer 222 may be 16×10¹⁸/cm² or more, 18×10¹⁸/cm² or more, 20×10¹⁸/cm² or more, 24×10¹⁸/cm² or less, 26×10¹⁸/cm² or less, 28×10¹⁸/cm² or less, or 30×10¹⁸/cm² or less. The charge trap layer 222 may have an electric field effect enhanced by high permittivity, and may have a charge storage efficiency improved by high charge storage density.

The charge trap layer 222 may include a quaternary or more elemental material to increase the trap site. For example, the charge trap layer 222 may include a matrix material having a high trap density and a crystallization control material that controls crystallization of the matrix material. A content of the matrix material in the charge trap layer 222 may be dominant as 80 at % or more, 85 at % or more, 90 at % or more, or 95 at % or more. A content of the crystallization control material in the charge trap layer 222 may be 20 at % or less, 15 at % or less, 10 at % or less, or 5 at % or less.

The matrix material may include an oxide nitride. For example, the matrix material may include at least one of aluminum oxynitride and silicon oxynitride. The matrix material may include not only nitrides but also oxides, which may realize low formation energy and deep trap charge states while having intrinsic defects due to nitrogen vacancies.

During the manufacturing process of a vertical non-volatile memory device 200, the matrix material may be crystallized by heat treatment such as a laser annealing treatment, etc. If the charge trap layer 222 is crystallized, a defect due to a grain boundary may be formed, and charge leakage may occur due to the above defect. Additionally or alternatively, the dielectric properties of the charge trap layer 222 may be deteriorated due to the above defect.

For example, in aluminum oxide nitride, nanostructured grains such as aluminum nitride (AlN) may be locally formed within the charge trap layer 222 through heat treatment, etc. This may act as a limit to increasing trap density. Therefore, even if the charge trap layer 222 is heat-treated, crystallization is suppressed and it is necessary or desirable to include a material that increases the trap density.

The crystallization control material according to some example embodiments may be or may include a material having a high critical crystallization temperature. The crystallization control material may have a higher critical crystallization temperature than a matrix. For example, the critical crystallization temperature of the crystallization control material may be about 1000° C. or higher. The crystallization control material may include at least one of hafnium nitride, aluminum nitride, boron nitride, gallium nitride, silicon oxide, aluminum oxide, magnesium oxide, zirconium carbide, hafnium carbide, silicon carbide, and aluminum carbide.

Since the charge trap layer 222 according to some example embodiments includes a crystallization control material, even if heat is applied to the charge trap layer 222, the material of the charge trap layer 222 does not crystallize but maintains an amorphous state, thereby improving thermal stability of the charge trap layer 222. Additionally or alternatively, new types of defects may be additionally generated by the crystallization control material, thereby improving the defect density and thus reducing charge leakage and enhancing dielectric properties.

The charge trap layer 222 may include nanocrystals. A content of nanocrystals in the charge trap layer 222 may be relatively small. The nanocrystals may be spherical and/or ellipsoidal in shape and may not be connected to each other as they are entirely surrounded by a matrix material in the charge trap layer 222. Thus, the nanocrystals do not induce charge transfer. For example, the content of nanocrystals in the charge trap layer 222 may be 10 at % or less, 7 at % or less, 5 at % or less, or 3 at % or less. A diameter of the nanocrystals may be about 0.5 nm or more, 1 nm or more, 2 nm or more, 3 nm or less, 4 nm or less, or 5 nm or less.

To include the nanocrystals, the charge trap layer 222 may include a crystallization control material having a relatively low critical crystallization temperature. The crystallization control material may have a lower critical crystallization temperature than the matrix material. For example, the crystallization control material may include at least one of hafnium oxide, zirconium oxide, indium oxide, zinc oxide, gallium oxide, yttrium oxide, barium oxide, tantalum oxide, strontium oxide, or scandium oxide.

The content of the crystallization control material having a relatively low critical crystallization temperature may be less than the content of the crystallization control material having a relatively high critical crystallization temperature. For example, the crystallization control material having a relatively low critical crystallization temperature with respect to the crystallization control material having a relatively high critical crystallization temperature may be about 0 at % or more, 5 at % or more, 10 at % or more, 15 at % or more, 25 at % or less, or 30 at % or less.

If the charges diffused in a charge trap layer 222 of the vertical non-volatile memory device 200 is measured, the vertical non-volatile memory device 200 is to be completed, which consumes a lot of cost and/or a lot of time. According to some example embodiments, the sample S may trap charges by using the same principle as a memory device.

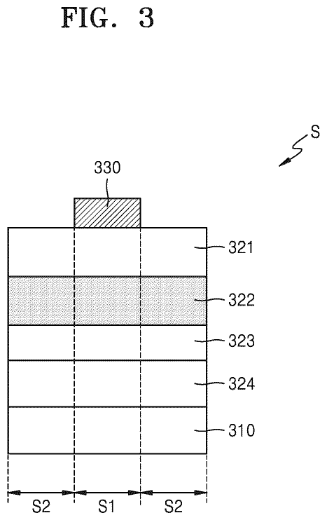

FIG. 3 illustrates the sample S schematically illustrating the vertical non-volatile memory device 200 of FIG. 2, according to some example embodiments.

The sample S according to some example embodiments may include a first conductive layer 310, a semiconductor layer 324 disposed on the first conductive layer 310, a charge tunneling layer 323 disposed on the semiconductor layer 324, the charge trap layer 322 disposed on the charge tunneling layer 323, a charge blocking layer 321 disposed on the charge trap layer 322, and a second conductive layer 330 disposed on the charge blocking layer 321.

The materials and thicknesses of the charge blocking layer 321, the charge trap layer 322, the charge tunneling layer 323, and the semiconductor layer 324 illustrated in FIG. 3 may correspond to the materials and thicknesses of the charge blocking layer 221, the charge trap layer 222, the charge tunneling layer 223, and the channel layer 224 illustrated in FIG. 2. The first conductive layer 310 may be or may include a printed circuit board (PCB) substrate, and the material of the second conductive layer 330 may correspond to the material of the gate electrode 231 illustrated in FIG. 2. The second conductive layer 330 may include a plurality of sub-conductive layers spaced apart from each other. The memory device of FIG. 2 is an example, and it should be understood that a sample according to some example embodiments may include a charge blocking layer, a charge trap layer, a charge tunneling layer, and a semiconductor layer corresponding to materials and thicknesses applied to vertical memory devices of other examples.

The sample S may be divided into a first region S1 including the second conductive layer 330 and a second region S2 not including the second conductive layer 330 in a thickness direction (Z-axis direction) of the sample S. When a voltage is applied to the charge trap layer 322 through the first and second conductive layers 310 and 330, charges may be trapped in the first region S1. The trapped charges may diffuse to the second region S2 over time, e.g., when a voltage is not applied. In some example embodiments, the atomic force microscope 100 may be used to measure charges diffused into the second region S2 of the sample S.

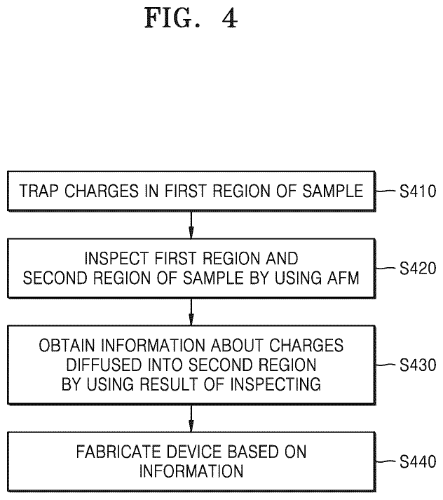

FIG. 4 is a flowchart illustrating a method of measuring diffused charges by using the atomic force microscope 100, according to some example embodiments.

Charges may be trapped in the first region S1 of the sample S (S410). As described above, the sample S may include the first conductive layer 310, the semiconductor layer 324, the charge tunneling layer 323, the charge trap layer 322, the charge blocking layer 321, and the second conductive layer 330. The semiconductor layer 324, the charge tunneling layer 323, the charge trap layer 322, the charge blocking layer 321, and the second conductive layer 330 may be sequentially arranged from a surface of the first conductive layer 310. The charge trap layer 322 may be arranged to extend to the first region S1 that overlaps with the second conductive layer 330 and the second region S2 that does not overlap with the second conductive layer 330. Charges may be trapped in the first region S1 of the sample S using the tip 121 of the atomic force microscope 100. However, the disclosure is not limited thereto. Charges may be trapped in the first region S1 by using a conductive layer other than the tip 121.

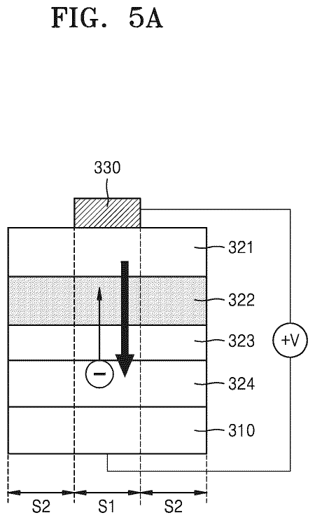

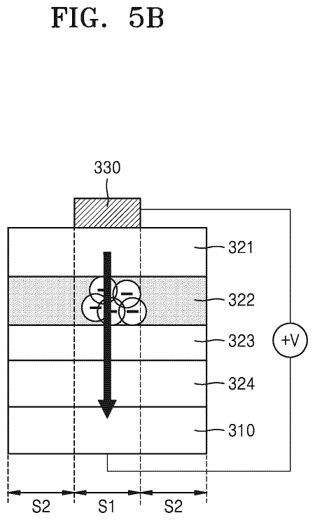

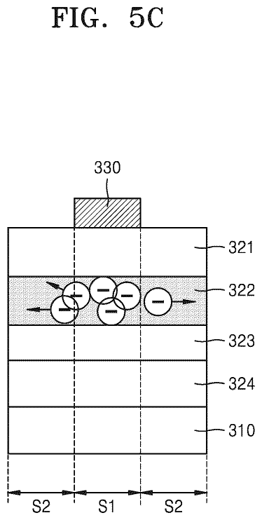

FIGS. 5A to 5C are reference diagrams describing a method of trapping electrons in the first region S1 of the sample S, according to some example embodiments. As illustrated in FIG. 5A, a voltage may be applied to the sample S such that an electric field is formed toward the semiconductor layer 324 in the second conductive layer 330. For example, a positive voltage may be applied to the second conductive layer 330 while the first conductive layer 310 is grounded.

As illustrated in FIG. 5B, electrons may be trapped in a portion of the charge trap layer 322, the portion being included in the first region S1 in which a strong electric field is formed. Electrons in the semiconductor layer 324 may tunnel through the charge tunneling layer 323, for example, through Fowler-Nordheim tunneling, and may be trapped in the charge trap layer 322. A mode in which electrons are trapped in the charge trap layer 322 may be called a program mode.

After the electric field formed in the charge trap layer 322 is extinguished, as time passes, the electrons may move in a direction parallel to a surface of the charge trap layer 322, as illustrated in FIG. 5C, and may diffuse to the charge trap layer 322 included in the second region S2. At high temperature, electrons may diffuse more quickly due to heat, such as by hopping and/or by Poole-Frenkel emission.

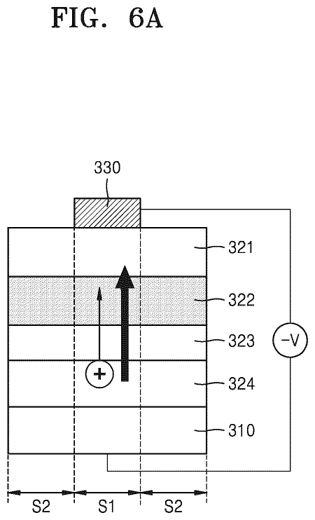

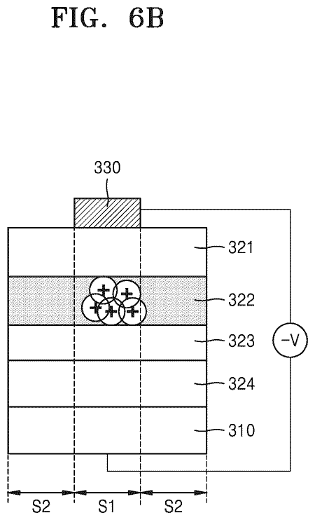

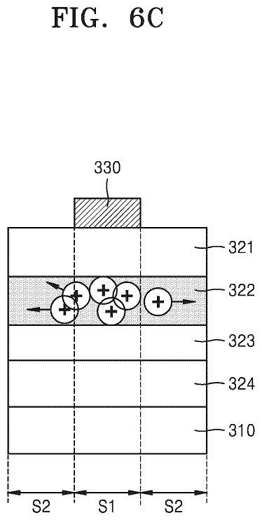

FIGS. 6A to 6C are reference diagrams describing a method of trapping holes in the first region S1 of the sample S, according to some example embodiments. As illustrated in FIG. 6A, a voltage may be applied to the sample S such that an electric field is formed toward the second conductive layer 330 in the semiconductor layer 324. For example, a negative voltage may be applied to the second conductive layer 330 while the first conductive layer 310 is grounded.

As illustrated in FIG. 6B, holes may be trapped in the portion of the charge trap layer 322, the portion being included in the first region S1 in which a strong electric field is formed. Holes in the semiconductor layer 324 may tunnel through the charge tunneling layer 323, for example, through Fowler-Nordheim tunneling, and be trapped in the charge trap layer 322. A mode in which holes are trapped in the charge trap layer 322 may be referred to as an erase mode. After the electric field formed in the charge trap layer 322 is extinguished, as time passes, the holes may move in a direction parallel to the surface of the charge trap layer 322, as illustrated in FIG. 6C, and may diffuse into the second region S2 of the sample S.

It may take a long time for the trapped charges in the sample S to diffuse along the surface of the charge trap layer 322. In some example embodiments, the method may further include heating the sample S after trapping charges in the first region S1. Diffusion of trapped charges may be accelerated by heating. For example, the sample S including the trapped charges may be heated in an oven to about 100° C.

Using the atomic force microscope 100, the first region S1 of the sample S and the second region S2 of the sample S adjacent to the first region S1 may be inspected (S420). The sample S may be inspected while the first and second conductive layers 310 and 330 are in a grounded state. By grounding the first and second conductive layers 310 and 330, noise caused by charges remaining in the first and second conductive layers 310 and 330 may be reduced.

The atomic force microscope 100 may obtain a surface topography image and/or a surface potential profile in an auto pulse frequency modulation (APFM) mode. For example, the tip 121 may be scanned in the first region S1 and the second region S2 without contacting the sample S. When the controller 170 applies a first alternating-current voltage, a second alternating-current voltage, and a direct-current voltage to the tip 121, the tip 121 may vibrate and scan the sample S. While the tip 121 scans the sample S, the light detector 150 may receive light emitted from the light source 140 and reflected from the cantilever 125, and the processor 160 may receive a direct-current voltage corresponding to the potential of the sample S from the controller 170. The processor 160 may obtain a topographic image of the sample S based on the detected laser beam, and may obtain a contact potential difference (CPD) or surface potential (SP) (hereinafter referred to as ‘surface potential’) of the sample S through a direct-current voltage corresponding to the potential of the sample S.

The processor 160 may obtain information about the charges diffused in the second region S2 of the sample S by using a result of the inspecting (S430). The processor 160 may obtain a topographic image of the surface of the sample S based on the detected laser beam and distinguish between the first region S1 and the second region S2 of the sample S. The processor 160 may obtain the contact potential difference (CPD) or surface potential (SP) (hereinafter referred to as ‘surface potential’) of the sample S through a Direct-current voltage corresponding to the potential of the sample S. Thus, the processor 160 may obtain a surface potential profile of the first region S1 and a surface potential profile of the second region S2.

The processor 160 may normalize the surface potential profile of the second region S2 based on the surface potential profile of the first region S1. The surface potential profile of the sample S may vary with each inspection due to damage to the tip 121, etc. As the second conductive layer 330 is arranged in an upper portion of the first region S1 of the sample S, even if charges are trapped in the first region S1, the surface potential profile of the first region S1 is mainly determined by a work function of the second conductive layer 330, and information such as damage to the tip 121 may be reflected. By normalizing the surface potential profile of the second region S2 based on the surface potential profile of the first region S1, errors or noise during inspection may be reduced. For example, an average value of the surface potential profile of the first region S1 may be used as a reference value, and the surface potential profile of the second region S2 may be normalized by a difference between the surface potential profile of the second region S2 and the reference value. Here the average value may be based on one or more of a mean, a median, or a mode, or other measure of central tendency, of the surface potential profile of the first region S1.

The processor 160 may obtain a diffusion coefficient of the charge trap layer 322 from the normalized surface potential profile of the second region S2 by using a diffusion model based on Fick's second law.

Diffusion of a charge distribution (C(x, t)) may be modeled using a diffusion model based on Fick's law as shown in Equation 2 below.

$$\frac{\partial C ( x , t )}{\partial t} = D \frac{{\partial }^{2} C ( x , t )}{\partial {x}^{2}} \qquad [ Equation 2 ]$$

Here, C(x, t) is a charge distribution, x is a distance, t is time, and D is a diffusion coefficient.

A solution to Equation 2 is as shown in Equation 3 below.

$$C ( x , t ) = \frac{M}{\sqrt{4 π Dt}} exp ( - \frac{{x}^{2}}{4 Dt} ) \qquad [ Equation 3 ]$$

Equation 3 follows a Gaussian profile, and a standard deviation (σ) and a diffusion coefficient (D) of the Gaussian profile are as shown in Equation 4 below.

$${σ}^{2} = 2 Dt \text{?} \qquad [ Equation 4 ]$$

$$\text{?} \text{indicates text missing or illegible when filed}$$

Thus, in some example embodiments, the processor 160 may Gaussian-fit the normalized surface potential profile and then apply Equation 4 to determine the diffusion coefficient from the standard deviation of the Gaussian-fitted surface potential profile.

As a sample according to some non-limiting example embodiments, a p-Si semiconductor layer, a charge tunneling layer of SiO₂, a charge trap layer of Si₃N₄, a charge blocking layer of SiO₂, and a second conductive layer of Ti/Au were formed on a first conductive layer of a PCB substrate. A thickness of the charge tunneling layer was about 3 nm, a thickness of the charge trap layer was about 6.5 nm, and a thickness of the charge blocking layer was about 7 nm. The thickness of the charge blocking layer was formed to be greater than the thickness of the charge tunneling layer, so that charges in the semiconductor layer moved by tunneling through the charge tunneling layer, whereas were not able to tunnel through the charge blocking layer.

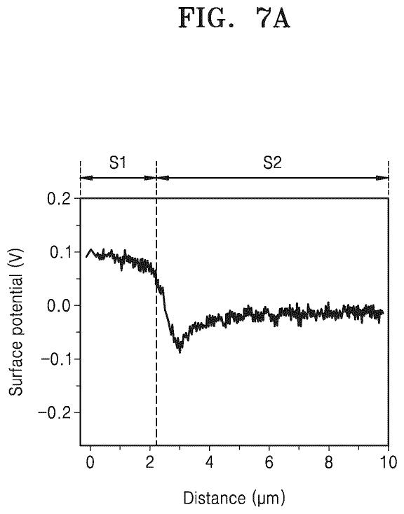

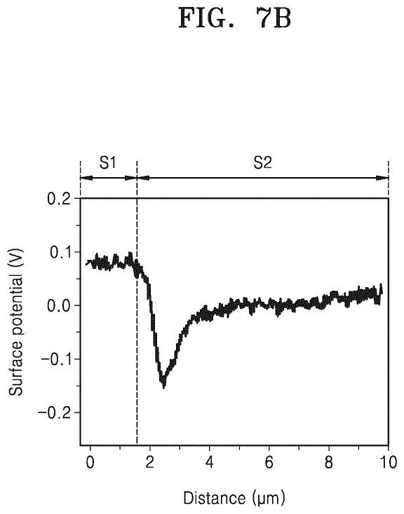

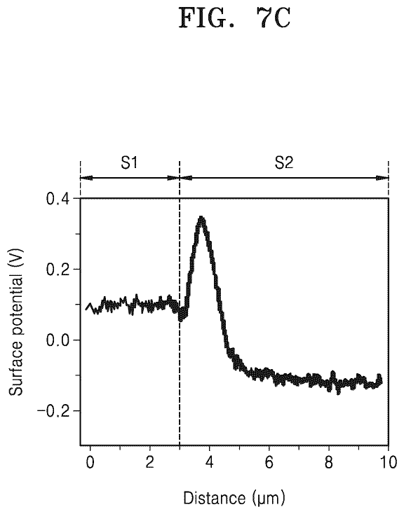

FIG. 7A is a diagram illustrating a surface potential profile before trapping charges in a sample including a charge trap layer, according to some example embodiments.

As illustrated in FIG. 7A, it may be confirmed that a potential difference between the second conductive layer and the charge blocking layer was approximately 0.2 V. Considering that the work functions of gold (Au) and SiO₂ are approximately 5.1 eV and 4.9 eV, respectively, the value of the potential difference may be confirmed to be reasonable.

Charges were trapped in the sample by applying a +20 V voltage to the sample for 10 ms by using a tip. Since a positive voltage is applied to the second conducting layer, electrons in the semiconductor layer may tunnel through the charge tunneling layer and be trapped in the charge trap layer. After heating the sample including trapped charges, in an oven at about 100° C. for about 10 hours, a surface potential profile was obtained in a KPFM mode. Although the trapped charges diffuse over a relatively long period of time, the sample was heated to determine whether the charges diffused within a relatively short period of time.

FIG. 7B is a diagram illustrating a surface potential profile after heating the sample including the trapped charges, according to some example embodiments.

Referring to FIG. 7B, it may be confirmed that the surface potential is rapidly lowered in a region of the second region S2, the region being adjacent to the first region S1. In FIG. 7A, a minimum surface potential of the second region S2 before charge trapping was approximately −0.077 V. After electrons were trapped in the sample and the sample was heated, the minimum surface potential of the second region S2 was approximately −0.14 V. This may indicate that the charges trapped in the first region S1 diffuse to the second region S2.

Meanwhile, charges were trapped in the sample by applying a −15 V voltage to the sample for 10 ms by using the tip. Since a negative voltage is applied to the second conducting layer, holes in the semiconductor layer may tunnel through the charge tunneling layer and be trapped in the charge trap layer. After heating the sample including trapped charges, in an oven at about 100° C. for about 10 hours, a surface potential profile was obtained in a KPFM mode.

FIG. 7C is a diagram illustrating a surface potential profile after heating the sample including the trapped charges, according to some example embodiments.

Referring to FIG. 7C, it may be confirmed that the surface potential increased rapidly in a region of the second region S2, the region being adjacent to the first region S1. In FIG. 7C, it may be confirmed that a maximum value of the surface potential of the second region S2 is approximately 0.35 V after the holes are trapped in the sample and the sample S is heated. This may indicate that the holes trapped in the first region S1 have diffused to the second region S2.

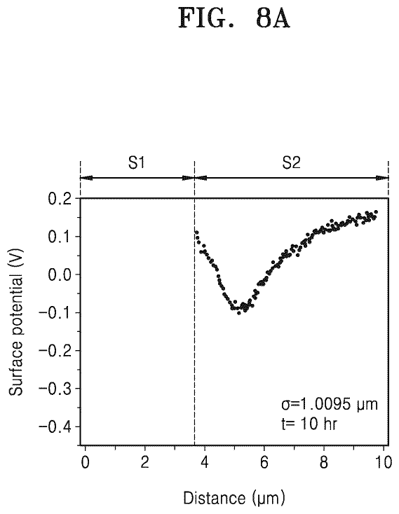

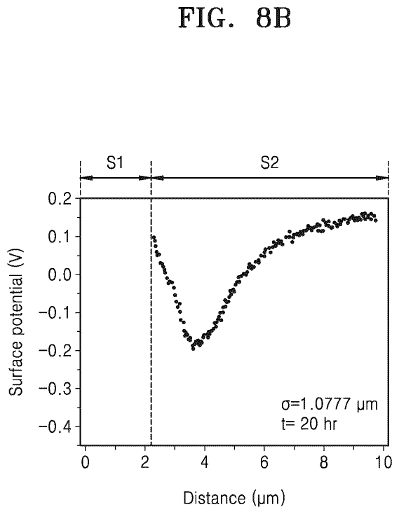

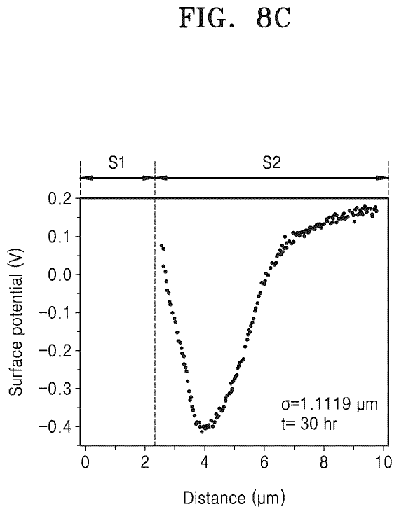

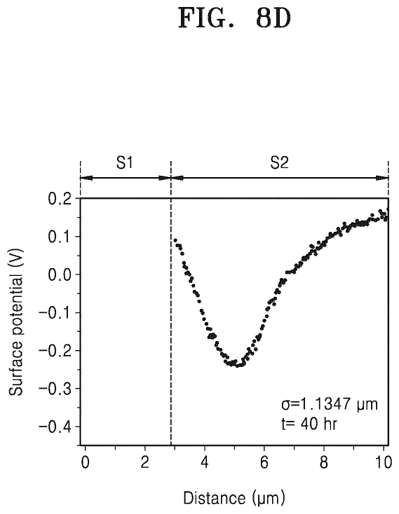

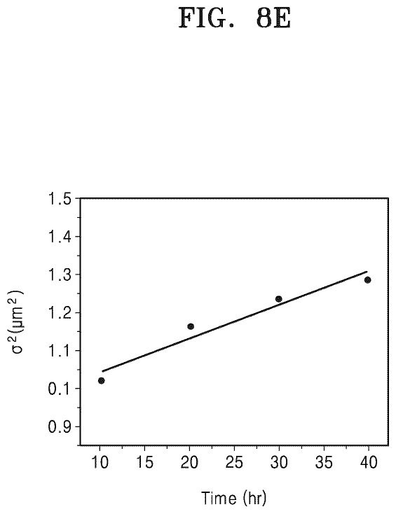

In some example embodiments, a sample including trapped electrons was heated for 10 hours and then the sample was measured to obtain a surface potential profile. The surface potential profile of the second region S2 was normalized to the surface potential profile of the first region S1. FIG. 8A is a normalized surface potential profile of the sample including trapped electrons, after heating for 10 hours, according to some example embodiments, FIG. 8B is a normalized surface potential profile of the sample including trapped electrons, after heating for 20 hours, according to some example embodiments, FIG. 8C is a normalized surface potential profile of the sample including trapped electrons, after heating for 30 hours, according to some example embodiments, and FIG. 8D is a normalized surface potential profile of the sample including trapped electrons, after heating for 40 hours, according to some example embodiments.

As the heating time increases, it may be confirmed that a decrease in the surface potential gradually spreads from the first region S1 toward the second region S2. After Gaussian-fitting the normalized surface potential profile of the second region S2, a standard deviation of the Gaussian-fitted surface potential profile may be obtained. The standard deviation of the sample heated for about 10 hours was about 1.0095 μm, while the standard deviation of the sample S heated for 40 hours was about 1.1347 μm.

FIG. 8E is a graph showing a square of the standard deviation for the Gaussian-fitted surface potential profile over time. Referring to FIG. 8E, it may be seen that the square of the standard deviation for the Gaussian-fitted surface potential profile is proportional to time. The graph of a linear function illustrated in FIG. 8E may be the diffusion coefficient of the charge trap layer 322, i.e., Si₃N₄. It may be confirmed in FIG. 8E that the diffusion coefficient of the charge trap layer 322 is approximately 1.222×10⁻¹⁴ cm²/s.

The atomic force microscope 100 according to some example embodiments may trap charges in a tunneling manner in the charge trap layer 322 of the sample S and may obtain information about the trapped charges, thereby increasing the accuracy of measurement.

Referring back to FIG. 4, in some example embodiments a device such as a semiconductor device may be fabricated based on the information (S440); example embodiments are not limited thereto.

Although the atomic force microscope and the method of operating the same have been described with reference to the embodiments illustrated in the drawings, these are merely examples, and those skilled in the art will understand that various modifications and equivalent other embodiments may be made therefrom. Although numerous details are specifically described in the above description, they should be construed as examples of embodiments rather than as limiting the scope of the disclosure. The scope of the disclosure should therefore not be defined by the described embodiments, but by the technical ideas described in the claims.

It should be understood that embodiments described herein should be considered in a descriptive sense only and not for purposes of limitation.

Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A method of measuring diffused charges, the method comprising:
trapping charges in a first region of a sample;
inspecting a first region of the sample and a second region of the sample, the second region adjacent to the first region, the inspecting the first and second regions by using an atomic force microscope; and
obtaining information about the charges diffused in the second region by using a result of the inspecting,
wherein the sample comprises:
a first conductive layer;
a semiconductor layer on the conductive layer;
a charge tunneling layer on the semiconductor layer;
a charge trap layer on the charge tunneling layer;
a charge blocking layer on the charge trap layer; and
a second conductive layer disposed on the charge blocking layer, and
wherein the second conductive layer is in the first region but not in the second region.

2. The method of claim 1, further comprising:
heating the sample after trapping the charges.

3. The method of claim 1, wherein the trapping of the charges comprises trapping electrons in a region included in the first region of the charge trap layer by applying a positive voltage to the second conductive layer.

4. The method of claim 1, wherein the trapping of the charges comprises trapping holes in a region included in the first region of the charge trap layer by applying a negative voltage to the second conductive layer.

5. The method of claim 1, wherein the trapping of the charges comprises applying voltage to the sample through a tip of the atomic force microscope.

6. The method of claim 1, wherein the inspecting is performed while the first conductive layer and the second conductive layer are grounded.

7. The method of claim 1, wherein the inspecting is performed while the atomic force microscope is in a non-contact mode.

8. The method of claim 7, wherein the non-contact mode comprises a Kelvin probe force microscope (KPFM) mode.

9. The method of claim 1, wherein the obtaining of the information about diffused charges comprises:
obtaining surface potential profiles of the first region and the second region;
normalizing the surface potential profile of the second region based on the surface potential profile of the first region; and
obtaining a diffusion coefficient of the charge trap layer from the normalized surface potential profile.

10. The method of claim 9, wherein the normalized surface potential profile is based on a difference between an average value of the surface potential profiles of the first region and the surface potential profile of the second region.

11. The method of claim 9, wherein the diffusion coefficient of the charge trap layer is based on a standard deviation of the normalized surface potential profile.

12. The method of claim 1, wherein the charge tunneling layer and the charge blocking layer comprise a same material as each other.

13. The method of claim 1, wherein at least one of the charge tunneling layer and the charge blocking layer comprises silicon oxide.

14. The method of claim 1, wherein a thickness of the charge blocking layer is greater than a thickness of the charge tunneling layer.

15. The method of claim 1, wherein the charge trap layer comprises silicon nitride.

16. The method of claim 1, wherein the first conductive layer comprises a printed circuit board (PCB) substrate.

17. An atomic force microscope comprising:
a tip configured to provide a voltage to a first region of a sample to trap charges in the sample;
a cantilever on which the tip is mounted;
a controller configured to apply a direct-current (DC) voltage and an alternating-current (AC) voltage to the cantilever while the tip scans a first region of the sample and a second region of the sample, the second region adjacent to the first region; and
a processor configured to obtain surface potential profiles of the first region and the second region of the sample based on a DC voltage corresponding to a potential of the sample,
wherein the sample comprises:
a first conductive layer;
a semiconductor layer on the conductive layer;
a charge tunneling layer on the semiconductor layer;
a charge trap layer on the charge tunneling layer;
a charge blocking layer on the charge trap layer; and
a second conductive layer on the charge blocking layer, and
wherein the second conductive layer is in the first region but not in the second region.

18. The atomic force microscope of claim 17, wherein the processor is further configured to normalize a surface potential profile of the second region based on a surface potential profile of the first region, and to obtain information about diffused charges by obtaining a diffusion coefficient of the charge trap layer from the normalized surface potential profile.

19. The atomic force microscope of claim 18, wherein the normalized surface potential profile is based on a difference between an average value of the surface potential profiles of the first region and the surface potential profile of the second region.

20. The atomic force microscope of claim 18, wherein the diffusion coefficient of the charge trap layer is based on a standard deviation of the normalized surface potential profile.
